(19) United States
(12) Patent Application Publication
(10) Pub. No.: US 2017/0310623 A1
(43) Pub. Date: Oct. 26, 2017

(54) IDENTIFYING A CONTENT ITEM PRESENTED BY A DIGITAL MAGAZINE SERVER IN A MESSAGE THREAD BETWEEN DIGITAL MAGAZINE SERVER USERS BASED ON INTERACTION WITH THE CONTENT ITEM

(71) Applicant: Flipboard, Inc., Palo Alto, CA (US)

(72) Inventor: Emil Sjolander, London (GB)

(21) Appl. No.: 15/139,287

(22) Filed: Apr. 26, 2016

(51) Int. Cl. H04L 12/58

(52) U.S. Cl. CPC H04L 51/16; H04L 51/04

(57) ABSTRACT

A digital magazine server user may identify a content item presented by the digital magazine server to identify in a thread of messages between the user and other users by interacting with a client device presenting the content item. For example, providing a gesture to the client device identifies the content item and causes presentation of one or more options to identify a thread of messages between users in which to include information identifying the content item. The gesture may begin by the user interacting with a portion of a display device that displays a portion of the content item and continue as the user interacts with the display device along a path from the portion to an additional portion. When an option is selected, the digital magazine server includes information identifying the content item in the thread corresponding to the selected option.

### BACKGROUND

This invention relates generally to interacting with content presented by a digital magazine server, and more specifically to including information identifying content presented by the digital magazine server in a thread of messages between users.

An application executing on a client device obtains content from an online system and presents the content to a user of the client device. The online system may select content for the user based on information associated with the user by the online system, allowing the application to present the user with content personalized for the user. In addition to presenting content to the user, the application receives actions by the user with content presented by the application. The application may communicate information describing the actions to the online system, which may subsequently select content additional content for the user based on the actions by the user with the presented content.

The user may perform a variety of actions with the application. For example, the user may share content presented by the application with additional users. In various embodiments, a source providing content presented by the application allows a user to recommend or identify the content to other users of the source based on interactions by the user with the application. However, different sources of content often have different mechanisms for identifying content items to additional users. Thus, to identify content items to other users of different sources, a user must become familiar with various interfaces provided by each source.

### SUMMARY

A digital magazine server retrieves content from one or more sources and generates a personalized, customizable digital magazine for a user based on the retrieved content. The generated digital magazine is retrieved by a digital magazine application, also referred to as an “application,” executing on a client device (such as a mobile communication device, tablet, computer, or any other suitable computing system). The application presents the digital magazine to the user and receives actions from the user with content presented by the application. Actions by the user with the application may be communicated to the digital magazine server, which selects content for the digital magazine based on the actions performed by the user. For example, based on selections made by the user via the application, the digital magazine server generates a digital magazine including one or more sections including content items retrieved from a number of sources and personalized for the user. The generated digital magazine allows the user to more easily consume content that interests and inspires the user by presenting content items in an easily navigable interface via a client device.

A user may perform a variety of actions with the application, with different actions providing the digital magazine server with information that may be used by the digital magazine server to select content for the user or to select content for other users. To allow the user to more easily identify a content item presented by the digital magazine server to other users, when the application receives an input from the user that interacts with a portion of a display device of the client device presenting a content item, the application sends an instruction identifying the content item to the digital magazine server. In various embodiments, the received input is the user contacting the portion of the display device and contacting the display device along a path from the portion to an additional portion, the user selecting an interface element presented by the display device, or the user performing any other suitable action. The application receives an option from the digital magazine server for including information identifying the content item in a thread of message including one or more messages communicated between the user and one or more additional users of the digital magazine server. In some embodiments, the application receives multiple options from the digital magazine server, with each option identifying different threads or different additional users. Additionally, the option may allow the user to establish a new thread of messages between the user and an additional user having a message that includes information identifying the content item.

When the application receives a selection of the option for including the content item in the thread, the application sends an instruction to the digital magazine server identifying the content item, the user, and one or more additional users associated with the thread. Based on the instruction, the digital magazine server includes information identifying the content item in the thread. For example, the digital magazine server communicates a message including information identifying the content item to one or more additional users associated with the thread. Information identifying the content item may be an image from the content item, a title of the content item, a subset of information included in the content item, or any other suitable information. Hence, based on the received instruction, the digital magazine server includes information identifying the content item inline with other messages in the thread, allowing additional users associated with the thread to more easily identify and access the content item.

### BRIEF DESCRIPTION OF THE DRAWINGS

FIG. 1 is a block diagram of a system environment in which a digital magazine server operates, in accordance with an embodiment of the invention.

FIG. 2 is a block diagram of a digital magazine server, in accordance with an embodiment of the invention.

FIG. 3 is an example of presentation of content items in a digital magazine using a page template, in accordance with an embodiment of the invention.

FIG. 4A is an example of content items presented by a digital magazine generated by a digital magazine server, in accordance with an embodiment of the invention.

FIG. 4B is an example messaging interface including a thread of messages between the user and one or more additional users having information identifying a content item presented in the digital magazine, in accordance with an embodiment of the invention.

FIG. 5 is an interaction diagram a method for including information identifying a content item presented by a digital magazine server in a thread of messages between users of the digital magazine server, in accordance with an embodiment of the invention.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Overview

A digital magazine server retrieves content from one or more sources and generates a personalized, customizable digital magazine for a user based on the retrieved content. The generated digital magazine is retrieved by a digital magazine application executing on a computing device (such as a mobile communication device, tablet, computer, or any other suitable computing system) and presented to the user. For example, based on selections made by the user and/or on behalf of the user, the digital magazine server generates a digital magazine including one or more sections including content items retrieved from a number of sources and personalized for the user. The generated digital magazine allows the user to more easily consume content that interests and inspires the user by presenting content items in an easily navigable interface via a computing device.

The digital magazine may be organized into a number of sections that each include content having a common characteristic (e.g., content obtained from a particular source). For example, a section of the digital magazine includes articles from an online news source (such as a website for a news organization), another section includes articles from a third-party-curated collection of content associated with a particular topic (e.g., a technology compilation), and an additional section includes content obtained from one or more accounts associated with the user and maintained by one or more social networking systems. For purposes of illustration, content included in a section is referred to herein as “content items” or “articles,” which may include textual articles, pictures, videos, products for sale, user-generated content (e.g., content posted on a social networking system), advertisements, and any other types of content capable of display within the context of a digital magazine.

### System Architecture

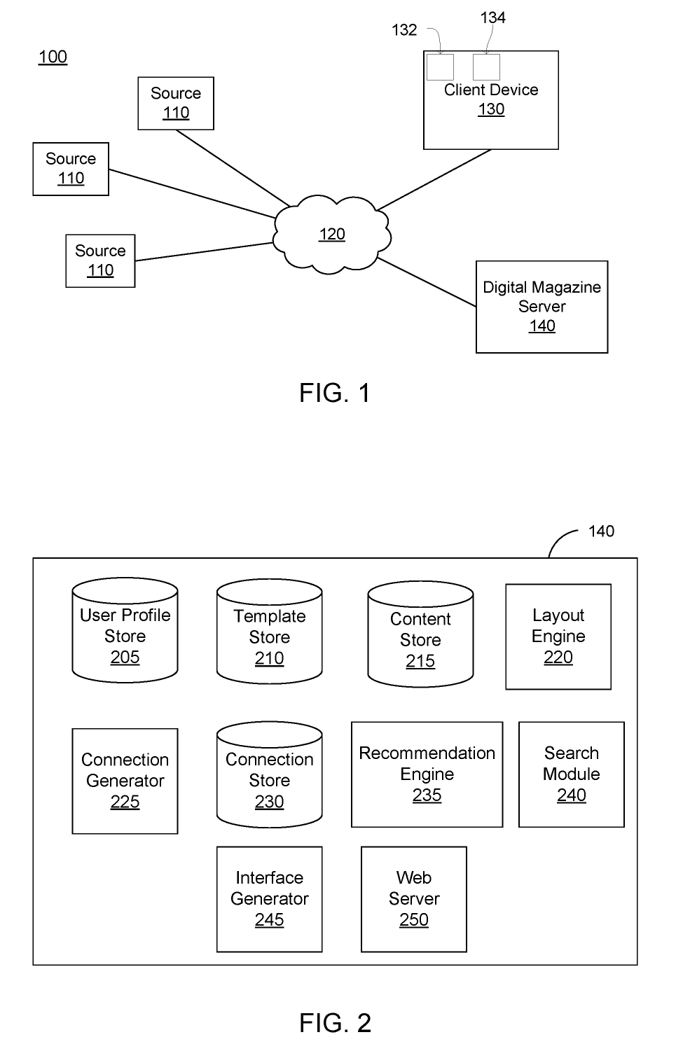

FIG. 1 is a block diagram of a system environment 100 for a digital magazine server 140. The system environment 100 shown by FIG. 1 comprises one or more sources 110, a network 120, a client device 130, and the digital magazine server 140. In alternative configurations, different and/or additional components may be included in the system environment 100. The embodiments described herein can be adapted to online systems that are not digital magazine severs 140.

A source 110 is a computing system capable of providing various types of content to a client device 130. Examples of content provided by a source 110 include text, images, video, or audio on web pages, web feeds, social networking information, messages, or other suitable data. Additional examples of content include user-generated content such as blogs, tweets, shared images, video or audio, social networking posts, and social networking status updates. Content provided by a source 110 may be received from a publisher (e.g., stories about news events, product information, entertainment, or educational material) and distributed by the source 110, or a source 110 may be a publisher of content it generates. For convenience, content from a source, regardless of its composition, may be referred to herein as an “article,” a “content item,” or as “content.” A content item may include various types of content, such as text, images, and video.

The sources 110 communicate with the client device 130 and the digital magazine server 140 via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) extensible markup language (XML) or JavaScript Object Notation (JSON). In some embodiments, all or some of the communication links of the network 120 may be encrypted using any suitable technique or techniques.

The client device 130 is one or more computing devices capable of receiving user input as well as transmitting and/or receiving data via the network 120. In one embodiment, the client device 130 is a conventional computer system, such as a desktop or a laptop computer. Alternatively, the client device 130 may be a device having computer functionality, such as a personal digital assistant (PDA), a mobile telephone, a smartphone or another suitable device. In one embodiment, the client device 130 executes an application allowing a user of the client device 130 to interact with the digital magazine server 140. For example, an application executing on the client device 130 communicates instructions or requests for content items to the digital magazine server 140 to modify content presented to a user of the client device 130. As another example, the client device 130 executes a browser that receives pages from the digital magazine server 140 and presents the pages to a user of the client device 130. In another embodiment, the client device 130 interacts with the digital magazine server 140 through an application programming interface (API) running on a native operating system of the client device 130, such as IOS® or ANDROID™. While FIG. 1 shows a single client device 130, in various embodiments, any number of client devices 130 may communicate with the digital magazine server 140.

A display device 132 included in the client device 130 presents content items to a user of the client device 130. Examples of the display device 132 include a liquid crystal display (LCD), an organic light emitting diode (OLED) display, an active matrix liquid crystal display (AMLCD), or any other suitable device. Different client devices 130 may have display devices 132 with different characteristics. For example, different client devices 132 have display devices 132 with different display areas, different resolutions, or differences in other characteristics.

One or more input devices 134 included in the client device 130 receive input from the user. Different input devices 134 may be included in the client device 130. For example, the client device 130 includes a touch-sensitive display for receiving input data, commands, or information from a user. Using a touch-sensitive display allows the client device 130 to combine the display device 132 and an input device 134, simplifying user interaction with presented content items. In other embodiments, the client device 130 may include a keyboard, a trackpad, a mouse, or any other device capable of receiving input from a user. Additionally, the client device may include multiple input devices 134 in some embodiments. Inputs received via the input device 134 may be processed by a digital magazine application associated with the digital magazine server 140 and executing on the client device 130 to allow a client device user to interact with content items presented by the digital magazine server 140.

The client device 130 executes an application 136 associated with the digital magazine server 140 that receives content form the digital magazine server 140 and presents the received content to a user associated with the client device 130. Additionally, the user performs various actions with the application 136, such as actions with content from the digital magazine server 140 presented by the application 136. For example, the application 136 presents various content items received from the digital magazine server 140 and receives actions from the user with one or more of the content items. Example actions by bye user with content items presented by the application 136 include: accessing a content item, viewing a content item, sharing a content item with another user of the digital magazine server 140, saving a content item to the client device 130, providing a comment associated with a content item, and providing a content item to the digital magazine server 140.

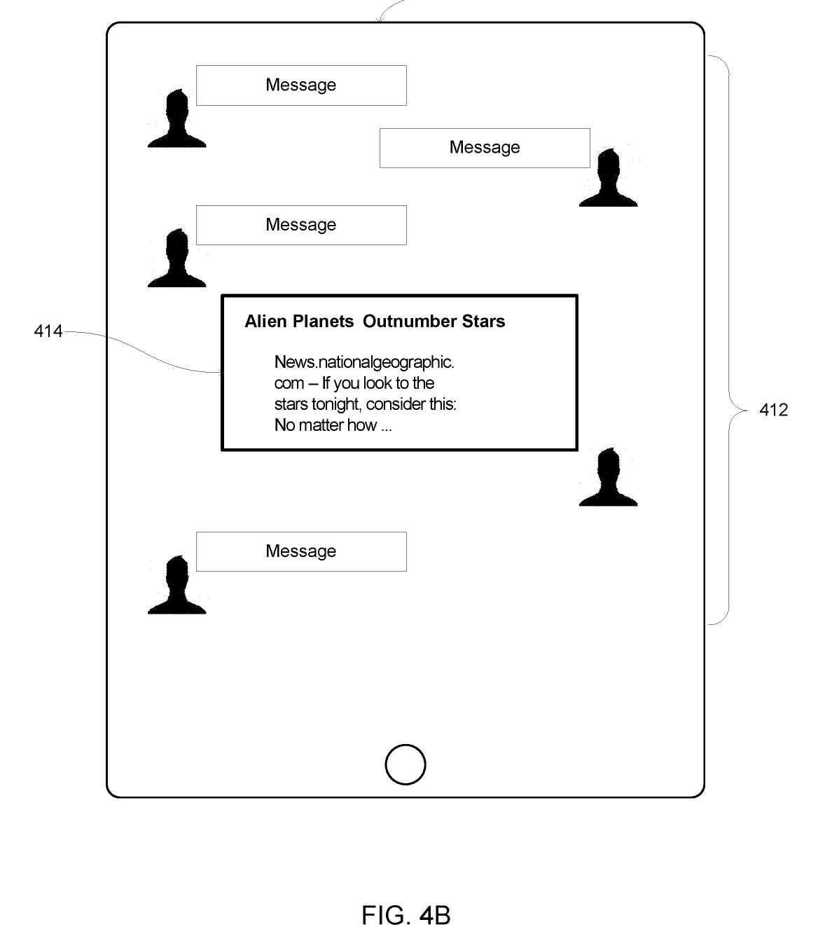

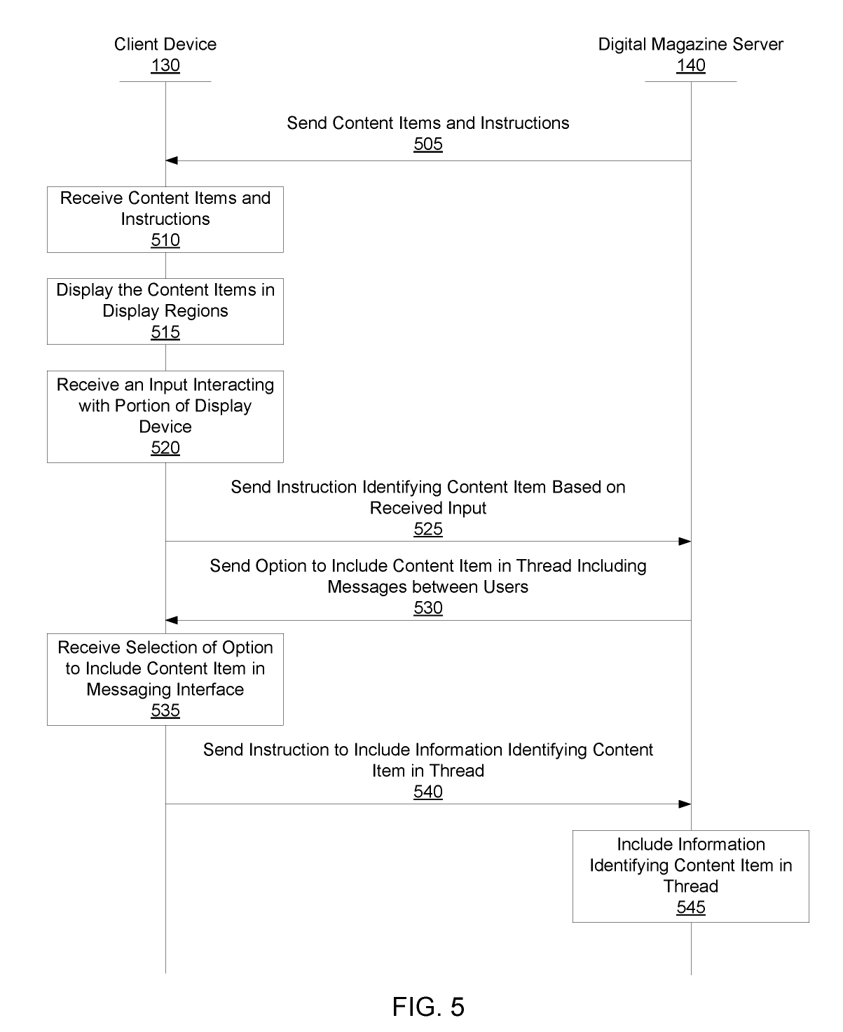

Additionally, the application 136 may allow users of the digital magazine server 140 to exchange messages with each other and maintain various threads associated with a user that include messages between the user and one or more additional users as well as identify the user and the additional user. A user identifies an additional user and one or more messages (e.g., text data, video data, image data, audio data) via the application 136, which communicates the messages and information identifying the additional user, as well as the user to the digital magazine server 140, which communicates the messages to the digital magazine server 140 for presentation. Additionally, if the application 136 receives a message from an additional user via the digital magazine server 140, the application 136 presents a notification to the user via the client device 110. For example, the notification is displayed in a region of the display device 132 of the client device and identifies the additional user as well as a portion of the received message. Interacting with the notification causes the application 136 to present the message to the user. In various embodiments, a user may perform one or more interactions with a content item presented by the digital magazine server 140 via the application 136 that communicate instructions to the digital magazine server 140 to include information identifying the content item in a thread of messages between the user and one or more additional users. Inclusion of information identifying a content item presented by the digital magazine server 140 in a thread of messages between a user and additional users is further described below in conjunction with FIGS. 4A-5.

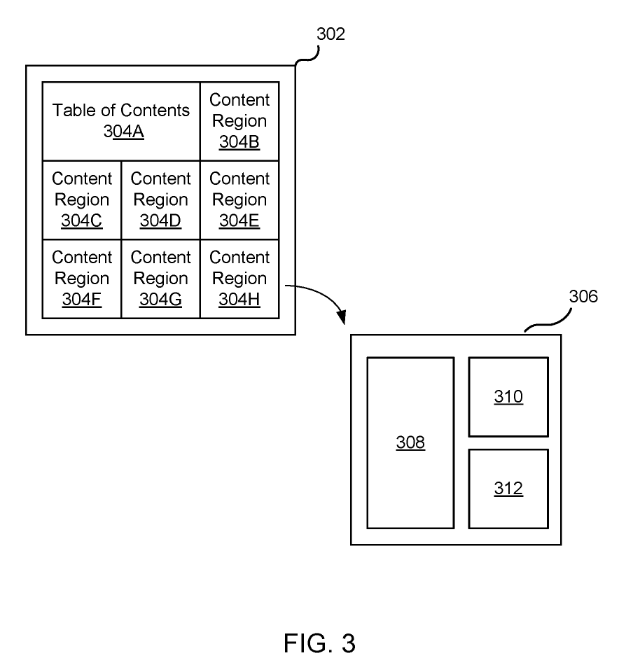

The digital magazine server 140 receives content items from one or more sources 110, generates pages in a digital magazine by processing the received content, and provides the pages to the client device 130. As further described below in conjunction with FIG. 2, the digital magazine server 140 generates one or more pages for presentation to a user based on content items obtained from one or more sources 110 and information describing organization and presentation of content items. For example, the digital magazine server 140 determines a page layout specifying positioning of content items relative to each other based on information associated with a user and generates a page including the content items arranged according to the determined layout for presentation to the user via the client device 130. This allows the user to access content items via the client device 130 in a format that enhances the user's interaction with and consumption of the content items. For example, the digital magazine server 140 provides a user with content items in a format similar to the format used by print magazines. By presenting content items in a format similar to a print magazine, the digital magazine server 140 allows a user to interact with content items from multiple sources 110 via the client device 130 with less inconvenience from horizontally or vertically scrolling to access various content items.

FIG. 2 is a block diagram of an architecture of the digital magazine server 140. The digital magazine server 140 shown in FIG. 2 includes a user profile store 205, a template store 210, a content store 215, a layout engine 220, a connection generator 225, a connection store 230, a recommendation engine 235, a search module 240, an interface generator 245, and a web server 250. In other embodiments, the digital magazine server 140 may include additional, fewer, or different components for various applications. Conventional components such as network interfaces, security functions, load balancers, failover servers, management and network operations consoles, and the like are not shown so as to not obscure the details of the system architecture.

Each user of the digital magazine server 140 is associated with a user profile, which is stored in the user profile store 205. A user profile includes declarative information about the user that was explicitly shared by the user and may also include profile information inferred by the digital magazine server 140. In one embodiment, a user profile includes multiple data fields, each describing one or more attributes of the corresponding digital magazine server user. Examples of information stored in a user profile include biographic, demographic, and other types of descriptive information, such as gender, hobbies or preferences, location, or other suitable information. A user profile in the user profile store 205 also includes data describing interactions by a corresponding user with content items presented by the digital magazine server 140. For example, a user profile includes a content item identifier, a description of an interaction with the content item corresponding to the content item identifier, and a time when the interaction occurred.

While user profiles in the user profile store 205 are frequently associated with individuals, allowing individuals to provide and receive content items via the digital magazine server 140, user profiles may also be stored for entities such as businesses or organizations. This allows an entity to provide or access content items via the digital magazine server 140. An entity may post information about itself, about its products or provide other content items associated with the entity to users of the digital magazine server 140. For example, users of the digital magazine server 140 may receive a digital magazine or section including content items associated with an entity via the digital magazine server 140.

The template store 210 includes page templates each describing a spatial arrangement (“layout”) of content items relative to each other on a page for presentation by a client device 130. A page template includes one or more slots, each configured to present one or more content items. In some embodiments, slots in a page template may be configured to present a particular type of content item or to present a content item having one or more specified characteristics. For example, a slot in a page template is configured to present an image while another slot in the page template is configured to present text data. Each slot has a size (e.g., small, medium, or large) and an aspect ratio. One or more page templates may be associated with types of client devices 130, allowing content items to be presented in different relative locations and with different sizes when the content items are viewed using different client devices 130. Additionally, page templates may be associated with sources 110, allowing a source 110 to specify the format of pages presenting content items received from the source 110. For example, an online retailer is associated with a page template to allow the online retailer to present content items via the digital magazine server 140 with a specific organization. Examples of page templates are further described in U.S. patent application Ser. No. 13/187,840, filed on Jul. 21, 2011, and U.S. patent application Ser. No. 13/938,227, filed on Jul. 9, 2013, each of which is hereby incorporated by reference in its entirety.

The content store 215 stores objects that each represent various types of content. For example, the content store 215 stores content items received from one or more sources 110 within a threshold time of a current time. Examples of content items stored by the content store 215 include a page post, a status update, an image, a photograph, a video, a link, an article, video data, audio data, a check-in event at a location, or any other type of content. A user may specify a section including content items having a common characteristic, and the common characteristic is stored in the content store 215 along with an association with the user profile or the user specifying the section.

The layout engine 220 retrieves content items from one or more sources 110 or from the content store 215 and generates a page including the content items based on a page template from the template store 210. Based on the retrieved content items, the layout engine 220 may identify candidate page templates from the template store 210, score the candidate page templates based on characteristics of the slots in different candidate page templates and based on characteristics of the content items. Based on the scores associated with candidate page templates, the layout engine 220 selects a page template and associates the retrieved content items with one or more slots to generate a page where the retrieved content items are presented relative to each other and sized based on their associated slots. When associating a content item with a slot, the layout engine 220 may associate the content item with a slot configured to present a specific type of content item or to present content items having one or more specified characteristics. Examples of using a page template to present content items are further described in U.S. patent application Ser. No. 13/187,840, filed on Jul. 21, 2011, U.S. patent application Ser. No. 13/938,223, filed on Jul. 9, 2013, and U.S. patent application Ser. No. 13/938,226, filed on Jul. 9, 2013, each of which is hereby incorporated by reference in its entirety.

The connection generator 225 monitors interactions between users and content items presented by the digital magazine server 140. Based on the interactions, the connection generator 225 determines connections between various content items, connections between users and content items, or connections between users of the digital magazine server 140. For example, the connection generator 225 identifies when users of the digital magazine server 140 provide feedback about a content item, access a content item, share a content item with other users, or perform other actions with content items. In some embodiments, the connection generator 225 retrieves data describing user interaction with content items from the user's user profile in the user profile store 205. Alternatively, user interactions with content items are communicated to the connection generator 225 when the interactions are received by the digital magazine server 140. The connection generator 225 may account for temporal information associated with user interactions with content items. For example, the connection generator 225 identifies user interactions with a content item within a specified time interval or applies a decay factor to identified user interactions based on times associated with interactions. The connection generator 225 generates a connection between a user and a content item if the user's interactions with the content item satisfy one or more criteria. In one embodiment, the connection generator 225 determines one or more weights specifying a strength of the connection between the user and the content item based on user interactions with the content item that satisfy one or more criteria. Generation of connections between a user and a content item is further described in U.S. patent application Ser. No. 13/905,016, filed on May 29, 2013, which is hereby incorporated by reference in its entirety.

If multiple content items are connected to a user, the connection generator 225 establishes implicit connections between each of the content items connected to the user. In one embodiment, the connection generator 225 maintains a user content graph identifying the implicit connections between content items connected to a user. In one embodiment, weights associated with connections between a user and content items are used to determine weights associated with various implicit connections between content items. User content graphs for multiple users of the digital magazine server 140 are combined to generate a global content graph describing connections between various content items provided by the digital magazine server 140 based on user interactions with various content items. For example, the global content graph is generated by combining user content graphs based on mutual connections between various content items in user content graphs.

In one embodiment, the connection generator 225 generates an adjacency matrix from the global content graph or from multiple user content graphs and stores the adjacency matrix in the connection store 230. The adjacency matrix describes connections between content items. For example, the adjacency matrix includes identifiers of content items and weights representing the strength or closeness of connections between content items based on the global content graph. As an example, the weights indicate a degree of similarity in subject matter or similarity of other characteristics associated with various content items. In other embodiments, the connection store 230 includes various adjacency matrices determined from various user content graphs; the adjacency matrices may be analyzed to generate an overall adjacency matrix for content items provided by the digital magazine server 140. Graph analysis techniques may be applied to the adjacency matrix to rank content items, to recommend content items to a user, or to otherwise analyze relationships between content items. An example of the adjacency matrix is further described in U.S. patent application Ser. No. 13/905,016, filed on May 29, 2013, which is hereby incorporated by reference in its entirety.

In addition to identifying connections between content items, the connection generator 225 may also determine a social proximity between users of the digital magazine server 140 based on interactions between users and content items. The digital magazine server 140 determines social proximity, or “social distance,” between users using a variety of techniques. For example, the digital magazine server 140 analyzes additional users connected to each of two users of the digital magazine server 140 within a social networking system to determine the social proximity of the two users. In another example, the digital magazine server 140 determines social proximity between a user and an additional user by analyzing the user's interactions with content items posted by the additional user, whether the content items are presented using the digital magazine server 140 or using another social networking system. Additional examples for determining social proximity between users of the digital magazine server 140 are described in U.S. patent application Ser. No. 13/905,016, filed on May 29, 2013, which is incorporated by reference in its entirety. In one embodiment, the connection generator 225 determines a connection confidence value between a user and an additional user of the digital magazine server 140 based on the user's and the additional user's common interactions with particular content items. The connection confidence value may be a numerical score representing a measure of closeness between the user and the additional user. For example, a larger connection confidence value indicates a greater similarity between the user and the additional user. In one embodiment, if a user has at least a threshold connection confidence value with another user, the digital magazine server 140 stores a connection between the user and the additional user in the connection store 230.

Using data from the connection store 230, the recommendation engine 235 identifies content items from one or more sources 110 for recommending to a digital magazine server user. Hence, the recommendation engine 235 identifies content items potentially relevant to a user. In one embodiment, the recommendation engine 235 retrieves data describing interactions between a user and content items from the user's user profile and data describing connections between content items, and/or connections between users from the connection store 230. In one embodiment, the recommendation engine 235 uses stored information describing content items (e.g., topic, sections, subsections) and interactions between users and various content items (e.g., views, shares, saved, links, topics read, or recent activities) to identify content items that may be relevant to a digital magazine server user. For example, content items having an implicit connection of at least a threshold weight to a content item with which the user interacted are recommended to the user. As another example, the recommendation engine 235 presents a user with content items having one or more attributes in common with a content item with which an additional user having a threshold connection confidence score with the user interacted. Recommendations for additional content items may be presented to a user when the user views a content item using the digital magazine, may be presented as a notification to the user by the digital magazine server 140, or may be presented to the user through any suitable communication channel.

In one embodiment, the recommendation engine 235 applies various filters to content items received from one or more sources 110 or from the content store 215 to efficiently provide a user with recommended content items. For example, the recommendation engine 235 analyzes attributes of content items in view of characteristics of a user retrieved from the user's user profile. Examples of attributes of content items include a type (e.g., image, story, link, video, audio, etc.), a source 110 from which a content item was received, time when a content item was retrieved, and subject matter of a content item. Examples of characteristics of a user include biographic information about the user, users connected to the user, and interactions between the user and content items. In one embodiment, the recommendation engine 235 analyzes attributes of content items in view of a user's characteristics for a specified time period to generate a set of recommended content items. The set of recommended content items may be presented to the user or may be further analyzed based on user characteristics and on content item attributes to generate more refined set of recommended content items. A setting included in a user's user profile may specify a length of time that content items are analyzed before identifying recommended content items to the user, allowing a user to balance refinement of recommended content items with time used to identify recommended content items.

The search module 240 receives a search query from a user and retrieves content items from one or more sources 110 based on the search query. For example, content items having at least a portion of an attribute matching at least a portion search query are retrieved from one or more sources 110. The user may specify sources 110 from which content items are received through settings maintained by the user's user profile or by identifying one or more sources in the search query. In one embodiment, the search module 240 generates a section of the digital magazine including the content items identified based on the search query, as the identified content items have a common attribute of their association with the search query. Presenting identified content items identified from a search query allows a user to more easily identify additional content items at least partially matching the search query when additional content items are provided by sources 110.

To more efficiently identify content items based on search queries, the search module 240 may index content items, groups (or sections) of content items, and user profile information. In one embodiment, the index includes information about various content items, such as author, source, topic, creation data/time, user interaction information, document title, or other information capable of uniquely identifying the content item. Search queries are compared to information maintained in the index to identify content items for presentation to a user. The search module 240 may present identified content items based on a ranking. One or more factors associated with the content items may be used to generate the ranking. Examples of factors include: global popularity of a content item among users of the digital magazine server 140, connections between users interacting with a content item and the user providing the search query, and information from a source 110. Additionally, the search module 240 may assign a weight to the index information associated with each content item selected based on similarity between the index information and a search query and rank the content items based on their weights. For example, content items identified based on a search query are presented in a section of the digital magazine in an order based in part on the ranking of the content items.

To increase user interaction with the digital magazine, the interface generator 245 maintains instructions associating received input with actions performed by the digital magazine server 140 or by a digital magazine application executing on a client device 130. For example, instructions maintained by the interface generator 245 associate types of inputs or specific inputs received via an input device 132 of a client device 130 with modifications to content presented by a digital magazine. As an example, if the input device 132 is a touch-sensitive display, the interface generator 245 includes instructions associating different gestures with navigation through content items or presented via a digital magazine. Instructions from the interface generator 245 are communicated to a digital magazine application or other application executing on a client device 130 on which content from the digital magazine server 140 is presented. Inputs received via an input device 132 of the client device 130 are processed based on the instructions when content items are presented via the digital magazine server 140 is presented to simplify user interaction with content presented by the digital magazine server 140. As further described below in conjunction with FIGS. 4A-5, the interface generator may communicate options identifying threads of messages between a user and one or more additional users based on an instruction received form the client device 130.

The web server 250 links the digital magazine server 140 via the network 120 to the one or more client devices 130, as well as to the one or more sources 110. The web server 250 serves web pages, as well as other content, such as JAVA®, FLASH®, XML and so forth. The web server 250 may retrieve content item from one or more sources 110. Additionally, the web server 250 communicates instructions for generating pages of content items from the layout engine 220 and instructions for processing received input from the interface generator 245 to a client device 130 for presentation to a user. The web server 250 also receives requests for content or other information from a client device 130 and communicates the request or information to components of the digital magazine server 140 to perform corresponding actions. Additionally, the web server 250 may provide application programming interface (API) functionality to send data directly to native client device operating systems, such as IOS®, ANDROIDTM, WEBOS®, or BlackberryOS.

For purposes of illustration, FIG. 2 describes various functionalities provided by the digital magazine server 140. However, in other embodiments, the above-described functionality may be provided by a digital magazine application executing on a client device 130, or may be provided by a combination of the digital magazine server 140 and the application 136 executing on a client device 130. For example, the digital magazine server 140 provides a set of rules each identifying desired actions for a user to perform and information describing actions previously performed by the user to the application 136. As the user interacts with the application 136, the application 136 identifies one or more rules including at least a threshold amount of information describing actions previously performed by the user matching actions performed by the user with the application. A desired action included in an identified rule is presented to the user by the application 136 to entice the user to perform the desired action via the application 136.

### Page Templates

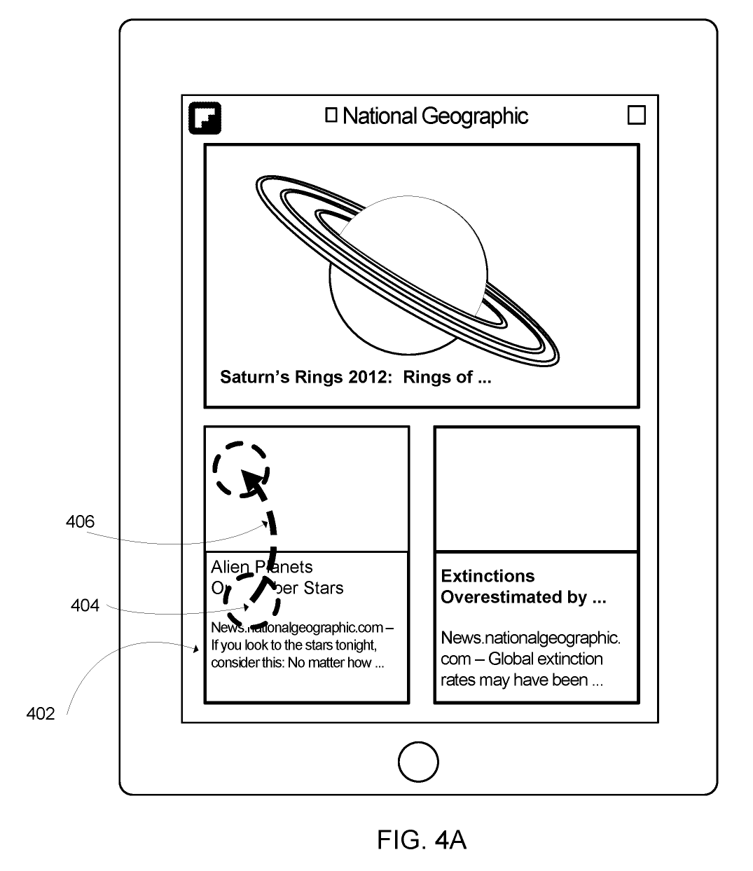

FIG. 3 illustrates an example page template 302 having multiple rectangular slots each configured to present a content item. Other page templates with different configurations of slots may be used by the digital magazine server 140 to present one or more content items received from sources 110. As described above in conjunction with FIG. 2, in some embodiments, one or more slots in a page template are reserved for presentation of content items having specific characteristics or for presentation of a specific type of content item. In one embodiment, the size of a slot may be specified as a fixed aspect ratio or using fixed dimensions. Alternatively, the size of a slot may be flexible, where the aspect ratio or one or more dimensions of a slot is specified as a range, such as a percentage of a reference or a base dimension. Arrangement of slots within a page template may also be hierarchical. For example, a page template is organized hierarchically, where an arrangement of slots may be specified for the entire page template or for one or more portions of the page template.

In the example of FIG. 3, when a digital magazine server 140 generates a page for presentation to a user, the digital magazine server 140 populates slots in a page template 302 with content items. Information identifying the page template 302 and associations between content items and slots in the page template 302 is stored and used to generate the page. For example, to present a page to a user, the layout engine 220 identifies the page template 302 from the template store 210 and retrieves content items from one or more sources 110 or from the content store 215. The layout engine 220 generates data or instructions associating content items with slots within the page template 302. Hence, the generated page includes various “content regions” presenting one or more content items associated with a slot in a location specified by the slot.

A content region 304 may present image data, text, data, a combination of image and text data, or any other information retrieved from a corresponding content item. For example, in FIG. 3, the content region 304A represents a table of contents identifying sections of a digital magazine, and content associated with the various sections are presented in content regions 304B-304H. For example, content region 304A includes text or other data indicating that the presented data is a table of contents, such the text “Cover Stories Featuring,” followed by one or more identifiers associated with various sections of the digital magazine. In one embodiment, an identifier associated with a section describes a characteristic common to at least a threshold number of content items in the section. For example, an identifier refers to the name of a user of social network from which content items included in the section are received. As another example, an identifier associated with a section specifies a topic, an author, a publisher (e.g., a newspaper, a magazine) or other characteristic associated with at least a threshold number of content items in the section. Additionally, an identifier associated with a section may further specify content items selected by a user of the digital magazine server 140 and organized as a section. Content items included in a section may be related topically and include text and/or images related to the topic.

Sections may be further organized into subsections, with content items associated with one or more subsections presented in content regions. Information describing sections or subsections, such as a characteristic common to content items in a section or subsection, may be stored in the content store 215 and associated with a user profile to simplify generation of a section or subsection for the user. A page template associated with a subsection may be identified, and slots in the page template associated with the subsection used to determine presentation of content items from the subsection relative to each other. Referring to FIG. 3, the content region 304H includes a content item associated with a newspaper to indicate a section including content items retrieved from the newspaper. When a user interacts with the content region 304, a page template associated with the section is retrieved, as well as content items associated with the section. Based on the page template associated with the section and the content items, the digital magazine server 140 generates a page presenting the content items based on the layout described by the slots of the page template. For example, in FIG. 3, the section page 306 includes content regions 308, 310, 312 presenting content items associated with the section. The content regions 308, 310, 312 may include content items associated with various subsections including content items having one or more common characteristics (e.g., topics, authors, etc.). Hence, a subsection may include one or more subsections, allowing hierarchical organization and presentation of content items by a digital magazine.

### Including Content Items from a Digital Magazine in a Thread of Messages

FIG. 4A shows an example of content items presented by a digital magazine generated by a digital magazine server 140. In the example of FIG. 4A, the digital magazine is presented to a user via a display device 132 of a client device 130 that is a touch-sensitive display. However, in other embodiments, the display device 132 includes one or more proximity sensors, one or more heat sensors, one or more resistive sensors, any other suitable types of sensors, and/or combinations of sensors. In one embodiment, a user interacts with a displayed content item 402 by interacting with the display device 132. For example, the user contacts a portion 404 of the display device 132 and continuously interacts with the display device 132 along a path 406 to provide an input. Alternatively, the user selects an icon, a button, or another interface element to provide the input. The icon, button, or other interface element may be presented proximate to the content item 402 or may be presented in a specific region of the digital magazine or in a specific region of the display device 132.

In an embodiment where a touch-sensitive display device 132 is used, the user may provide the input by contacting a portion 404 of the display device 132 and maintaining contact with the display device 132 while traversing a path 406. The path 406 comprises moving from the portion 404 of the display device 132 towards an additional portion of the display device 132 in a direction of motion when an intermediate location, between the portion 404 and the additional portion, is reached. For example, one path 406 is moving from the portion 404 of the display device 132 to the additional portion of the display device 132 by moving upward towards and to the right of the additional portion and, at the intermediate location between the portion 404 and the additional portion, moving left of the portion 404. Other paths include additional intermediate locations between the portion and additional portion and additional directions of motion. In various embodiments, different inputs may be provided by the user contacting the portion 404 of the display device 132 and traversing different paths while maintaining contact with the display device 132. For example, traversing the path 406 causes presentation of a set of options to the user, while traversing a different path causes presentation of an alternative set of options to the user. As additional examples, one path may cause options to be sent from the digital magazine server 140 and other paths may cause different actions relating to the content item 402 to be performed. For example, a circular path saves the content item 402 to the digital magazine server 140, a triangular path corresponds to including information identifying the content item 402 in a thread of messages between the user and one or more additional users of the digital magazine server 140, and a diagonal path corresponds to commenting on the content item 402. The performed actions and paths can be retrieved from the user profile of the user or the settings of the application executing on the client device 130 in one embodiment.

When the input is completed, one or more options are presented to the user, including an option to include the content item 402 in a thread of messages between the user and one or more additional users. For example, an interface displaying one or more options, including the option to include the content item 402 in the thread, is presented to the user. Various options may be presented, such as: an option to attach supplemental content to the content item 402 to a message sent to another user, an option to share the content item 402 with one or more additional users, an option to identify users to receive the content item 402, an option to include information identifying the content item 402 in a thread of messages between the user and other users, or other suitable options. In one embodiment, multiple options to share the content item 402 are presented, allowing the user to select from various communication channels (e.g., e-mail, social networking system, digital magazine server 140, text message, etc.) to share the content item 402. In an e-mail communication channel embodiment, the user is further prompted with a comment interface or the comment option in the interface. Additionally, the user may identify users of the digital magazine server 140, users of another system, such as a social networking system, a digital magazine maintained by the digital magazine server 140, or other suitable entities to receive the content item 402. Alternatively, the user may identify a thread of messages between the user and one or more additional users. Options for sharing a content item and interactions with the content item are further described below in conjunction with FIG. 5.

The interface may present pop-up displays to assist the user in selecting recipients for the content item or for information describing the content item. For example, if the user physically contacts the option for saving the content item 402, a pop-up display appears adjacent to the interface in a row and displays potential locations for saving the content item 402, such as digital magazines or storage locations on a client device 130. In other embodiments, locations for saving the content item 402 are displayed or arranged in any other suitable manner in a pop-up display. For example, the pop-up display is a scroll bar presented adjacent to the interface 408 and displays the possible recipients in a column.

Similarly, an interface identifying threads of messages between the user and additional users or identifying additional users to receive a message from the user may be displayed if the user provides an input to include information identifying the content item 402 in a thread including messages between one or more additional users and the user. Additional users or threads of messages may be identified based on a frequency with which the user communicates messages to additional user (e.g., additional users with whom the user communicates messages with at least a threshold frequency), additional users with whom the user has most recently communicated messages, threads of messages to which the user has most recently provided a message, threads of messages to which the user provides messages with at least a threshold frequency, or other suitable criteria. In other embodiments, additional users or threads including messages between the user and additional users are identified based on attributes of the content item, attributes of the user, attributes of the additional users, attributes of the additional users included in a thread, or any combination thereof.

After selecting one or more of the presented options, the user may manually complete interaction with the content item 402 by accessing an input element, such as a button, icon, or other graphical element. For example, after the user accesses an input element corresponding to including the content item 402 in a thread including one or more messages between the user and one or more additional users, information identifying the content item 402 in the thread. FIG. 4B shows an example messaging interface 410 including a thread 412 of messages between the user and one or more additional users. In the example of FIG. 4B, the user has selected the option to include information identifying the content item 402 in the thread 412, which causes the digital magazine server 140 to include information 414 identifying the content item 402 in the thread 412. As shown in FIG. 4B, the information 414 identifying the content item 402 is presented in the thread 412 along with messages between the user and one or more other users. While FIG. 4B shows the information 414 identifying the content item 402 as textual data, in various embodiments, the information 414 may be image data (e.g., a thumbnail image of the content item 402, a thumbnail image of an image from the content item 402), video data, a combination of text data, image data, and video data, or any other suitable data.

FIG. 5 illustrates an interaction diagram of one embodiment of a method for including information identifying a content item presented by a digital magazine server 140 in a thread of messages between users of the digital magazine server 140. In other embodiments, the method may include different and/or additional steps than those shown in FIG. 5. The functionality described in conjunction with the client device 130 in FIG. 5 may be provided by the client device 130 or by an application 136 executing on the client device 130 in various embodiments. Additionally, in various embodiments, the steps of the method may be performed in different orders than the order described in conjunction with FIG. 5.

The digital magazine server 140 sends 505 one or more content items and instructions for displaying the one or more content items to a client device 130, which receives 510 the content items and instructions. For example, the digital magazine server 140 sends 505 the one or more content items and instructions in response to a request for content items received from the client device 130, or sends 505 one or more content items and instructions for displaying the content items to the client device 130 at various time intervals (e.g., periodic time intervals). In one embodiment, the instructions for displaying one or more of the content items are retrieved from an application 136 executing on the client device 130 and associated with the digital magazine server, while the content items are received 510 from the digital magazine server 140, which retrieves the content items from the content store 215 or from one or more sources 110. Alternatively, the instructions may include page templates retrieved from the template store 210 of the digital magazine server 140 that describe relative positioning of content items to each other when displayed. As further described above in conjunction with FIGS. 2 and 3, the page templates have one or more content regions specifying locations in which content items are displayed in a page of a digital magazine.

Based on the instructions, the client device 130 displays 515 one or more of the content items in various display regions of a display device 132 included on the client device 130. For example, content regions are displayed 515 in various positions in the display device 132 determined by slots in a page template. In one embodiment, the content items are displayed in a page of a digital magazine presented via the display device 132.

The client device 130 receives 520 an input from the user interacting with a portion of the display device 132 of the client device 130, such as a display region presenting a content item is displayed in the portion of the display device 132. In one embodiment, the input is received 520 when the user interacts with the portion of the display device 132 and continues to interact with the display device 132 along a path from the portion to an additional portion of the display device 132. For example, if the display device 132 is a touch-sensitive display, the input is received 520 when the user contacts the portion of the display device 132 and maintains physical contact with the display device 132 from the portion to the additional portion of the display device 132. This interaction with the display device 132 allows the user to easily interact with a presented content item by performing a gesture with the display device 132. Alternatively, the client device 130 receives 520 the input when the user accesses or selects an interface element, such as an icon, a button, or a link, displayed in the portion of the display device 132 or in another portion of the display device 132. In other embodiments, the input may be received 520 through other suitable methods. For example, the input is received 520 when the user contacts the portion of the display device 132 with a physical stylus and continues contacting the display device 132 with the physical stylus while traversing the path to the additional portion of the display device 132. Other examples of inputs received 520 include a user positioning a stylus or other object (e.g., a finger, a stylus pen, etc.) within a threshold distance above the surface of the portion of the display device 132 and traversing a path above the surface of the display device 132, a user positioning the stylus or other object within the threshold distance above the surface of the portion of the display device 132 and traversing a path towards the surface of the display device 132, a sensor identifying eye contact by the user with the portion of the display device 132 and the user maintaining eye contact with the display device 132 along a path from the portion to the additional portion, receiving an audio command via an audio capture device, moving the client device 130 along a specified path, or any other suitable type of input. In an embodiment where the input is an audio command, the input is received 520 when a phrase or other audio signal with a specific signature is received by a microphone or other audio capture device included on the client device 130.

In one embodiment, the portion is an area of the display region in which a corner of the content item is displayed. In other embodiments, the portion and/or the additional portion display additional features of the content item. Examples of displayed features of the content item include one or more corners of the content item, a border, a title, a section, an image, a video, or a visual indication of a location such as a point, an icon, or a button. Alternatively, the additional portion includes a visual indication of a specific region of the display device, such as an icon, an image, a shape, or any other suitable data. For example, instead of the path shown by the dotted arrow in FIG. 4A, the path may be circular, where the portion and the additional portion are the same. Additional examples of a path include different shapes or patterns such as a rectangle, an ellipse, a triangle, an “x,” a diagonal line, and a curved line.

When the input is received 520, the client device 130 sends 525 an instruction identifying the content item presented by the portion of the display device 132 with which the user interacted to the digital magazine server 140. In one embodiment, the instruction includes an identifier associated with the content item, such as a uniform resource locator (URL) associated with the content item; alternatively, a content identifier associated with the content item by the digital magazine server 140, or any other information identifying the content item, is included in the instruction. In various embodiments, additional information may be included in the instruction, such as one or more attributes of the content item. Example attributes of the content item include one or more of: a title, an author, a source, a type, a size, an identifier, and timestamp information.

When the digital magazine server 140 receives the instruction identifying the content item from the client device 130, the digital magazine server 140 sends 530 an option to include the content item in a thread that includes messages between the user and one or more additional users to the client device 130. In various embodiments, the digital magazine server 140 may also send additional options, such as one or more options for sharing the content item with additional digital magazine server users to the client device 130. Additionally, the digital magazine server 140 may send 530 various options to the client device 130, with different options identifying different threads of messages between the user and additional users or identifying additional users with whom to create a thread. For example, different options may identify different threads to which the user communicated a message within a threshold time from a current time, different threads to which the user communicates messages at greater than a threshold frequency, or different threads with which the user has communicated at least a threshold number of messages. As another example, different options identify threads associated with different additional users to whom the user communicates messages with at least a threshold frequency, different additional users to whom the user has communicated at least a threshold number of messages within a specific time interval, different additional users with whom the user has communicated messages within a threshold time of a current time, or different additional users having at least a threshold number of characteristics matching characteristics of the user. Examples of other options that may be sent by the digital magazine server 140 to the client device 130 are further described in U.S. patent application Ser. No. 14/024,518, filed on Sep. 11, 2013, which is hereby incorporated by reference in its entirety.

In some embodiments, the digital magazine server 140 selects options for sending 525 to the client device 130 based on a type of instruction received from the client device 130 or based on information describing the received input in the instruction received from the client device 130. For example, based on characteristics of the received input, the client device 130 selects from different instructions to send 525 or includes information describing the received input in the sent instruction. If the input is a path from a portion to an additional portion of the display device 132, example characteristics of the received input include: rate, force, direction, and duration. In one embodiment, if the instruction indicates that the input was completed in greater than a threshold time interval, one or more options for including the content item in a set of threads of messages are selected by the digital magazine server 140 and sent 530 to the client device; however, if the instruction indicates that the input was completed in less than the threshold time interval, or in the threshold time interval, the instruction identifies the content item and the digital magazine server 140 includes information identifying the content item in one or more threads including messages between the user and additional users based on settings associated with the user (e.g., a specific set of additional users identified and stored in the user profile).

One or more options sent 530 to the client device 130 may be selected based on information associated with the user by the digital magazine server 140. For example, information in the user's user profile maintained by the digital magazine server 140 or settings stored by an application executing on the client device 130 and associated with the digital magazine server 140 are used to identify threads or additional users identified by various options sent 530 to the client device 130. In other embodiments, the options are filtered by the digital magazine server 140 or by an application executing on the client device 130 and associated with the digital magazine server 140 based on attributes of the user, attributes of additional users included in a thread, attributes of the content item, or any other suitable information. Example attributes of the identified content item include: a title, an author, a source 110, a type, a size, an identifier, and a topic. Examples of attributes of the user include preferences, prior interactions with content item, and additional users connected to the user.

The client device 130 presents the option to include the content item in a thread including messages between the user and one or more additional users or presents multiple options to include the content item in different threads including messages between the user and one or more additional users. For example, one or more of the received options are presented via an interface presented on the display device 132, allowing the user to select from one or more threads in which to include information identifying the content item or from various additional users to generate a thread including information identifying the content item. This allows the user to select from various threads including messages communicated to or received from various additional users. If the user interacts with a presented option, one or more additional options may be presented. For example, if the user interacts with an option to include information identifying the content item in a thread including messages between the user and one or more additional users, the user may be presented with additional options to include supplemental information along with the information identifying the content item, such as text for inclusion in a message. However, any suitable supplemental information may be included along with the information identifying the content item in various embodiments. Further, in some embodiments, the option presented to the user allows the user to identify one or more additional users to receive a message including information identifying the content item, allowing the user to include the message in an existing thread between the user and an identified additional user or to create a thread between the user and the identified additional user including the message.

When the client device 130 receives 535 a selection of the option to include information identifying the content item in a thread, an instruction to share the content item based on the selected option is sent 540 to the digital magazine server 140. The instruction includes information identifying the content item, information identifying the user, and information identifying the thread or one or more additional users included in the thread. For example, the instruction includes an identifier of the content item and additional information, such as a title of the content item, a user who authored the content item, a source 110 associated with the content item, a portion of the content item, or any other suitable information. Based on information in the instruction identifying a thread or identifying one or more additional users, the digital magazine server 140 includes 545 information identifying the content item in the thread or in a thread including one or more messages between the user and the identified one or more additional users. For example, the digital magazine server 140 includes 545 a message including information identifying the content item in a thread between the user and one or more additional users. As an example, the digital magazine server 140 includes 545 a message including an image from the content item, a title of the content item, and a portion of the content item in a thread identified by the instruction in in a thread between the user and one or more additional users identified by the instruction.

In various embodiments, the digital magazine server 140 also stores information associated with the content item and with the user in response to receiving the instruction to include the information identifying the content item in the thread. For example, the digital magazine server 140 associates data with the user identifying the content item and indicating the user included information identifying the content item in the thread; the data associated with the user may also include identifiers corresponding to the additional users associated with the thread. Additionally, the digital magazine server 140 may associate data with an identifier of the content item indicating the content item was included in a thread and identifiers corresponding to the user and the additional users included in the thread. Subsequently, the digital magazine server 140 may use the stored information when selecting additional content items for presentation to the user or to the additional users. For example, the stored information increases the likelihood of the digital magazine server 140 selecting additional content items having at least a threshold number or percentage of characteristics matching characteristics of the content item to the user or to the additional users associated with the thread.

The digital magazine server 140 may also communicate notifications to the additional users included in the thread in addition to including 545 the information identifying the content item in the thread. A notification to an additional user is communicated from the digital magazine server 140 to a client device 130 associated with the additional user, where an application 136 associated with the digital magazine server 140 executing on the client device 130 presents the notification to the additional user. When presented to the additional user, the notification includes a subset of the information identifying the content item, such as a title of the content item, in addition to identifying the user.

As shown in the example of FIG. 4B, including 545 the information identifying the content item in the thread including messages between the user and one or more additional users allows the content item to be identified inline with messages between the user and the additional users, increasing the likelihood of the additional users subsequently interacting with the content item. In various embodiments, the information identifying the content item also includes instructions, that when executed by a client device 130, retrieve the content item and present the content item, allowing an additional user to access the content item from the thread. For example when an additional user accesses the information identifying the content item, the instructions included in the information identifying the content item are executed by the client device 130 presenting the information identifying the content item; hence, the content item is retrieved from the digital magazine server 140 or from a source 110 and presented by the client device 130 presenting the information identifying the content item.

### SUMMARY

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method for interacting with content items included in a digital magazine, the method comprising:
receiving one or more content items from a digital magazine server and instructions for displaying the content items on a client device to a user of a digital magazine server;
displaying the one or more content items in display regions of a display device included on the client device;
receiving an input from the user interacting with a portion of the display device of the client device corresponding to a display region presenting a content item;
responsive to the received input, sending an instruction identifying the content item presented by the portion of the display device corresponding to the display region with which the user interacted to the digital magazine server;
receiving an option from the digital magazine server for including information identifying the content item presented by the portion of the display device corresponding to the display region with which the user interacted in a thread that includes messages communicated between the user and one or more additional users of the digital magazine server;
receiving a selection of the option for including information identifying the content item presented by the portion of the display device corresponding to the display region with which the user interacted in the thread; and
sending an instruction to the digital magazine server to include information identifying the content item presented by the portion of the display device corresponding to the display region with which the user interacted in a message included in the thread based on the selected option.

2. The method of claim 1, wherein receiving the input from the user interacting with the portion of the display device of the client device corresponding to the display region presenting a content item comprises:
receiving an input from the user interacting with the portion of the display device of the client device corresponding to the display region presenting the content item and continuously interacting with the display device along a path from the portion of the display device of the client device to an additional portion of the display device of the client device.

3. The method of claim 1, wherein receiving the input from the user interacting with the portion of the display device of the client device corresponding to the display region presenting a content item comprises:
receiving a selection of an interface element presented in association with the portion of the display device of the client device corresponding to the display region presenting the content item.

4. The method of claim 1, wherein the instructions sent from the digital magazine server identify the relative positioning of content items when displayed.

5. The method of claim 1, wherein the information identifying the content item is selected from a group consisting of: an image from the content item, a title of the content item, a source associated with the content item, a subset of content included in the content item, and any combination thereof.

6. The method of claim 1, wherein the information identifying the content item includes instructions that, when executed by an additional client device, retrieve the content item from the digital magazine server and present the content item via the additional client device.

7. The method of claim 1, wherein receiving the option from the digital magazine server for including information identifying the content item presented by the portion of the display device corresponding to the display region with which the user interacted in the thread that includes messages communicated between the user and one or more additional users of the digital magazine server comprises:
receiving a plurality of options from the digital magazine server, each option associated with a thread associated with an additional user of the digital magazine server.

8. A method comprising:
sending one or more content items from a digital magazine and instructions for presenting the content items to a client device for presentation to a user of a digital magazine server;
receiving an instruction identifying a content item from the digital magazine presented by the client device;
sending an option for including information identifying the content item in a thread that includes messages communicated between the user and one or more additional users of the digital magazine server to the client device;
receiving an instruction from the client device to include information identifying the content item in a message included in the thread;
including the information identifying the content item in the message included in the thread; and
communicating the message including the information identifying the content item to the one or more additional users.

9. The method of claim 8, wherein the information identifying the content item is selected from a group consisting of: an image from the content item, a title of the content item, a source associated with the content item, a subset of content included in the content item, and any combination thereof.

10. The method of claim 8, wherein the information identifying the content item includes instructions that, when executed by an additional client device, retrieve the content item from the digital magazine server and present the content item via the additional client device.

11. The method of claim 8, wherein sending the option for including information identifying the content item in the thread that includes messages communicated between the user and one or more additional users of the digital magazine server to the client device comprises:
identifying a plurality of threads including the user, each thread including one or more messages between the user and an additional user; and
sending a plurality of options from the digital magazine server to the client device, each option associated with an identified thread.

12. The method of claim 11, wherein identifying the plurality of threads including the user comprises:
identifying threads to which the user has communicated messages at greater than a threshold frequency.

13. The method of claim 11, wherein identifying the plurality of threads including the user comprises:
identifying threads to which the user has communicated at least a threshold number of messages.

14. The method of claim 8, wherein identifying the plurality of threads including the user comprises:
identifying one or more additional users to whom the user has communicated at least a threshold number of messages; and
identifying threads including messages from the user to at least one of the additional users.

15. The method of claim 8, further comprising:
storing information associated with the content item indicating inclusion of information identifying the content item in the thread in response to receiving the instruction.

16. The method of claim 8, further comprising:
storing information associated with the user indicating the user included information identifying the content item in the thread in response to receiving the instruction.
